(19) United States
(12) Patent Application Publication
(10) Pub. No.: US 2015/0030258 A1
(43) Pub. Date: Jan. 29, 2015

(54) SYSTEM AND METHOD OF CORNER NOISE REDUCTION IN AN IMAGE

(71) Applicant: QUALCOMM Incorporated, San Diego, CA (US)

(72) Inventors: Yunqiang Chen, San Diego, CA (US); Xiaoyun Jiang, San Diego, CA (US)

(73) Assignee: QUALCOMM Incorporated, San Diego, CA (US)

(21) Appl. No.: 14/222,282

(22) Filed: Mar. 21, 2014

Related U.S. Application Data
(60) Provisional application No. 61/858,901, filed on Jul. 26, 2013.

(51) Int. Cl. G06T 5/00

(52) U.S. Cl. CPC G06T 5/002
USPC 382/266

(57) ABSTRACT

Systems and methods for reducing noise artifacts in an image are disclosed. A radial distance-based look up table may be used to calibrate a noise property change due to the vignette effect. Based on the look up table, a spatial varying noise reduction level is computed to correct the noise property distortion due to the image vignetting.

### RELATED APPLICATIONS

This application claims the benefit of U.S. Provisional Application No. 61/858,901, filed Jul. 26, 2013, titled “SYSTEM AND METHOD OF CORNER NOISE REDUCTION IN AN IMAGE,” the disclosure of which is hereby incorporated by reference in its entirety.

### BACKGROUND

1. Field of the Invention

Embodiments relate to systems and methods of reducing noise artifacts in digital images. More specifically, embodiments relate to image noise reduction in the corners of a captured digital image.

2. Description of the Related Art

Electronic noise is inherent to all captured electronic images, but its cause varies. It is more apparent is some images, and barely noticeable in others. Higher ISO values will enhance this effect, as will underexposure or long exposure. Process over-sharpening will also enhance electronic noise. Some images may contain a combination of chromatic (color) and luminance (monochromatic) noise.

In cameras, light provided by the camera optics is often significantly reduced around sensor corners than the center, which is commonly known as “vignetting.” Spatial varying digital gain needs to be applied to compensate for the darkness in the corners, which is sometime referred to as “roll-off correction.” However, such spatial varying digital gain can distort the noise properties of an image and complicate the imaging noise reduction algorithms that are located behind roll-off correction step in the imaging pipeline. To correctly model the imaging noise, the spatial varying digital gain information is passed through an imaging pipeline to all of the processing modules that depend on correct noise properties. This can be extremely costly to the ISP design.

### SUMMARY

The systems, methods and devices of the disclosure each have several innovative aspects, no single one of which is solely responsible for the desirable attributes disclosed herein. Combinations of the innovations, aspects and features described herein can be incorporated in various embodiments of systems, methods, and devices, and such combinations are not limited by the examples of embodiments described herein.

Embodiments and innovations described herein relate to systems and methods that may be run in an imaging pipeline, or some or all of other image processing modules or components that depend on noise properties to correct for distortion of noise properties in an image. Such embodiments can be used to process single (still) images or video (a plurality of images). This distortion can be caused by any processing modules that can introduce spatial varying digital gain such as roll-off correction, local tone mapping and the like. The functionality of such method and system embodiments may be referred to herein as Corner Noise Reduction (CNR). By using CNR as an early process in the imaging pipeline, the operational cost to pass the spatial varying gain through the imaging pipeline can be avoided. Regarding the order between CNR and roll-off correction step, it is actually quite flexible. The proposed CNR can be located either before or after a roll-off correction step, with some minor modifications.

As discussed below, some implementations use CNR after roll-off correction, however embodiments are not limited to this order. A person of ordinary skill in the art will appreciate that other embodiments can be implemented before a roll-off correction step.

One innovation relates to a system and method for reducing noise artifacts in a digital image by using a radial distance-based look up table to calibrate a noise property change in an image due to vignetting. Based on the look up table, a spatial varying noise reduction level is computed to correct the noise property distortion due to the vignetting and applied to the image. Embodiments allow existing noise reduction processes to be used effectively without being complicated by spatial varying processing. Such embodiments can be efficient and do not introduce too much complexity to the device hardware.

One aspect relates to a system for digital image noise reduction, including an imaging device configured to capture image data, a memory for storing image data, the image data comprising a plurality of pixels, and a processor configured to perform a method. The method may include the steps of determining a noise variance amplification factor for each pixel, determining a noise reduction level and an order to apply to each pixel, calculating the expected noise of each pixel, estimating a confidence factor of the expected noise based on a noise distribution of the image, performing noise reduction for each pixel of the image based on the expected noise, the confidence factor, the noise reduction level and the order to obtain noise reduced image data, and storing the noise reduced image data in the memory. In some aspects, the processor is further configured to group the plurality of pixels into a plurality of super pixels containing one or more pixels of the image data.

In another aspect, a processor for reducing noise artifacts in a digital image may be configured with a plurality of modules. The modules may include a first module configured to determine noise artifacts in a digital image having a plurality of pixels and a second module configured to determine an amplification factor for each pixel to compensate for image vignetting by reducing the determined noise artifacts by applying a noise filter having a spatially varying digital gain, such that noise artifacts near the center of the image are processed differently than the noise artifacts near the corners of the captured digital image. In some aspects, the second module is further configured to determine a noise reduction level and order based on a noise level of each pixel of the image as compared to a pixel having normal digital gain applied. In some aspects, the second module is further configured to use a radial distance based look up table to calibrate the noise property distortion due to image vignetting. In some aspects, pixels of the captured digital image are grouped into super pixels containing two or more of the pixels of the captured digital image. In some aspects, the pixels are grouped into super pixels depending on a lighting condition of the capture digital image. In some aspects, a roll-off correction is performed on the digital image prior to applying a noise filter having a spatially varying digital gain.

In yet another aspect, a method of reducing noise artifacts in a captured digital image includes the steps of determining noise artifacts in a digital image having a plurality of pixels and applying a noise filter having a spatially varying digital gain to determine an amplification factor for each pixel to compensate for image vignetting in the digital image so that noise artifacts near the center of the image are processed differently than the noise artifacts near the corners of the captured digital image. In some aspects, the method further includes calibrating a digital gain change for each pixel. In some aspects, the method further includes determining an order level that controls the level of compensation globally and computing a noise reduction level for each pixel based on the determined order level. In some aspects, the method further includes grouping the plurality of pixels into a plurality of super pixels containing one or more pixels of the image data. In some aspects, the method further includes calculating an expected noise value of each of the plurality of pixels. In some aspects, the method further includes estimating a confidence factor of the expected noise value based on a noise distribution of the image. In some aspects, the method further includes performing noise reduction for each of the plurality of pixels of the image based on the expected noise, the confidence factor, the noise reduction level and the order to obtain noise reduced image data. In some aspects, the method further includes storing the noise reduced image data in a memory for further processing.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram depicting a system implementing some operative elements of corner noise reduction of an image.

FIG. 2 is a flow chart illustrating a process for corner noise reduction as part of an image noise reduction process.

FIG. 3 is a schematic diagram illustrating a process for corner noise reduction as part of an image noise reduction process.

FIG. 4 is a typical noise sigma ratio look up table for use in a corner noise reduction module.

FIG. 5 is a schematic diagram illustrating the formation of a super pixel.

### DETAILED DESCRIPTION

Many modules in an imaging pipe line of an electronic device may be (at least partially) dependent on an accurate model of noise that is in a captured image, and the modules may have built-in processes to handle any such imaging noise. Some examples of processes to handle certain types of imaging noise include, for example, de-speckle, non-linear filtering, median filtering, and adaptive image enhancement. Corner noise reduction (CNR) processes are designed to compensate for the non-stationary effect of noise caused by any spatial varying digital gain, typically affecting the corners of an image, without adding more complexities to existing noise reduction modules (e.g., to compensate for image vignetting). “Non-stationary noise” refers to noise in which the variance of the noise is spatially variant within the image. Specifically, the non-stationary noise effect can result in images with uncertain input data. For example, the variance of noise at the center of an image is relatively lower than the variance of noise at the corners of the image. Accordingly, CNR functionality described herein is not used to fully remove the imaging noise, and for regions that have a normal noise level, the described CNR module should not be relied on to reduce the noise. For the regions in an image that include significantly stronger noise due to higher digital gain, (for example, the corners of an image) CNR can be used to reduce the amplified noise to a normal level so that the other imaging modules can ignore the non-stationary digital gain.

In some embodiments, a CNR process is implemented in a processing module prior to the application of another noise reduction strategy. Some other noise reduction algorithms must be modified to account for spatially-varying noise. This can result in costly hardware redesigns. Some examples of CNR processes disclosed herein can be implemented as a pre-processing step to correct for spatially-varying noise that does not require modification of the existing noise reduction algorithms. In some embodiments, the CNR pre-processes the image data to address the spatially variant (non-stationary) noise and make the noise more stationary (that is, the noise distribution is more consistent spatial-wise across the image). Additional noise reduction of the image may be accomplished by other noise reduction algorithms.

Because the amount of noise variance may be more prevalent in one or more corners of an image, a CNR process described herein may apply objective criteria to achieve more stable noise data across the image to create a similar noise variance (or distribution) across the image such that a noise reduction algorithm can address the more “stable” (consistent) noise variance.

Embodiments of the innovations described herein may be implemented in System-on-Chip (SoC) or external hardware, software, firmware, or any combination thereof. Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Examples of a corner noise reduction (CNR) system or process may contain the following components: (1) model of the spatial varying noise property; (2) spatial varying noise reduction level; and (3) a super-pixel based noise reduction component. These components are described in more detail in the following subsections.

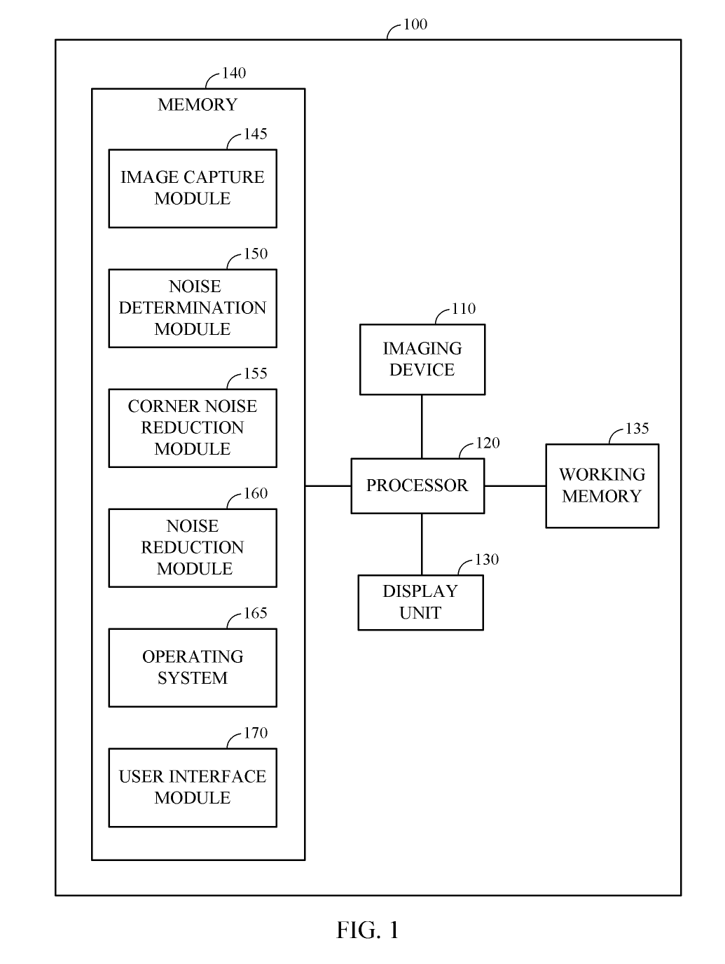

It is also noted that examples, embodiments and implementations referenced herein may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function. The functionality of such processes may be implemented in software and/or hardware components, for example, as illustrated in FIG. 1.

### System Overview

FIG. 1 illustrates one example of an embodiment of an imaging system 100 configured to perform corner noise reduction on an image. The illustrated embodiment is not meant to be limiting, but is rather illustrative of certain components in some embodiments. System 100 may include a variety of other components for other functions which are not shown for clarity of the illustrated components.

The imaging system 100 may include an imaging device 110 and a display unit 130. Certain embodiments of display unit 130 may be any flat panel display technology, such as an LED, LCD, plasma, or projection screen. Display unit 130 may be coupled to the processor 120 for receiving information for visual display to a user. Such information may include, but is not limited to, visual representations of files stored in a memory location, software applications installed on the processor 120, user interfaces, and network-accessible content objects.

Imaging device 110 may employ one or a combination of imaging sensors. The image stabilization system 100 can further include a processor 120 linked to the imaging device 110. A working memory 135, electronic display 130, and program memory 140 are also in communication with processor 120. The image stabilization system 100 may be a stationary device such as a desktop personal computer or it may be a mobile device, such as a tablet, laptop computer, or cellular telephone.

Processor 120 may be a general purpose processing unit or it may be a processor specially designed for imaging applications. As shown, the processor 120 is connected to, and in data communication with, program memory 140 and a working memory 135. In some embodiments, the working memory 135 may be incorporated in the processor 120, for example, cache memory. The working memory 135 may also be a component separate from the processor 120 and coupled to the processor 120, for example, one or more RAM or DRAM components. In other words, although FIG. 1 illustrates two memory components, including memory component 140 comprising several modules and a separate memory 135 comprising a working memory, one with skill in the art would recognize several embodiments utilizing different memory architectures. For example, a design may utilize ROM or static RAM memory for the storage of processor instructions implementing the modules contained in memory 140. The processor instructions may then be loaded into RAM to facilitate execution by the processor. For example, working memory 135 may be a RAM memory, with instructions loaded into working memory 135 before execution by the processor 120.

In the illustrated embodiment, the program memory 140 stores an image capture module 145, a noise determination module 150, a corner noise reduction module 155, a noise reduction module 160, operating system 165, and a user interface module 170. These modules may include instructions that configure the processor 120 to perform various image processing and device management tasks. Program memory 140 can be any suitable computer-readable storage medium, such as a non-transitory storage medium. Working memory 135 may be used by processor 120 to store a working set of processor instructions contained in the modules of memory 140. Alternatively, working memory 135 may also be used by processor 120 to store dynamic data created during the operation of image stabilization system 100.

As mentioned above, the processor 120 may be configured by several modules stored in the memory 140. In other words, the processor 120 can run instructions stored in modules in the memory 140. Imaging capture module 145 may include instructions that configure the processor 120 to obtain images from the imaging device. Therefore, processor 120, along with image capture module 145 and imaging device 110, represent one means for obtaining image data of a scene of interest.

Still referring to FIG. 1, memory 140 may also contain noise determination module 150. The noise determination module 150 includes instructions that configure the processor 120 to model the spatial varying gain exhibited by the pixels in the image data, and the any adjustments (for example, gain) applied to different pixels to compensate for the spatially varying noise in an image, as will be described in further detail below. Therefore, processor 120, along with noise determination module 150 and working memory 135, represent one means for determining the digital gain applied to pixels of the image.

Memory 140 may also contain corner noise reduction module 155. The corner noise reduction module 155 includes instructions that configure the processor 120 to determine and apply a noise reduction level based on certain criteria, for example, the pixel's noise sigma, as will be described in further detail below. Therefore, processor 120, along with corner noise reduction module 155 and working memory 135, represent one means for determining and applying a spatial varying noise reduction level globally to the image and achieve more stable noise data such that a later noise reduction module (for example, noise reduction module 160) can process the image and address overall noise reduction of the image.

Non-spatially variant (or stationary) noise data resulting from pre-processing by the corner noise reduction module 155 may be passed to the noise reduction module 160, also contained within memory 140. The noise reduction module 160 may include instructions that, when run on the processor 120, reduce the noise of an image using the noise data provided by the corner noise reduction module 155. Therefore, processor 120, along with corner noise reduction module 155, noise reduction module 160, and working memory 135, are an example of means for reducing the noise of an image.

Memory 140 may also contain user interface module 170. The user interface module 170 illustrated in FIG. 1 includes instructions that configure the processor 120 to provide a collection of on-display objects and soft controls that allow the user to interact with the device. The user interface module 170 also allows applications to interact with the rest of the system in a uniform, abstracted way. An operating system 165 may also reside in memory 140 and operate with processor 120 to manage the memory and processing resources of system 100. For example, operating system 165 may include device drivers to manage hardware resources such as the electronic display 130 or imaging device 110. In some embodiments, instructions contained in the noise determination module 150 and corner noise reduction module 155 may not interact with these hardware resources directly, but instead interact through standard subroutines or APIs located in operating system 165. Instructions within operating system 165 may then interact directly with these hardware components.

Although FIG. 1 depicts an example of a device comprising separate components to include a processor 120, an imaging device 110, display with 130 and memory 140, 135, one skilled in the art would recognize that these separate components may be combined in a variety of ways to achieve particular design objectives. For example, in an alternative embodiment, the memory components may be combined with processor components to save cost and improve performance. In other embodiments, the image device 110 may not be housed with the processor. In such embodiments, the image data from the imaging device 110 may be provided to the system 100 for processing as described.

### Corner Noise Reduction—Model of the Spatial Varying Noise Property

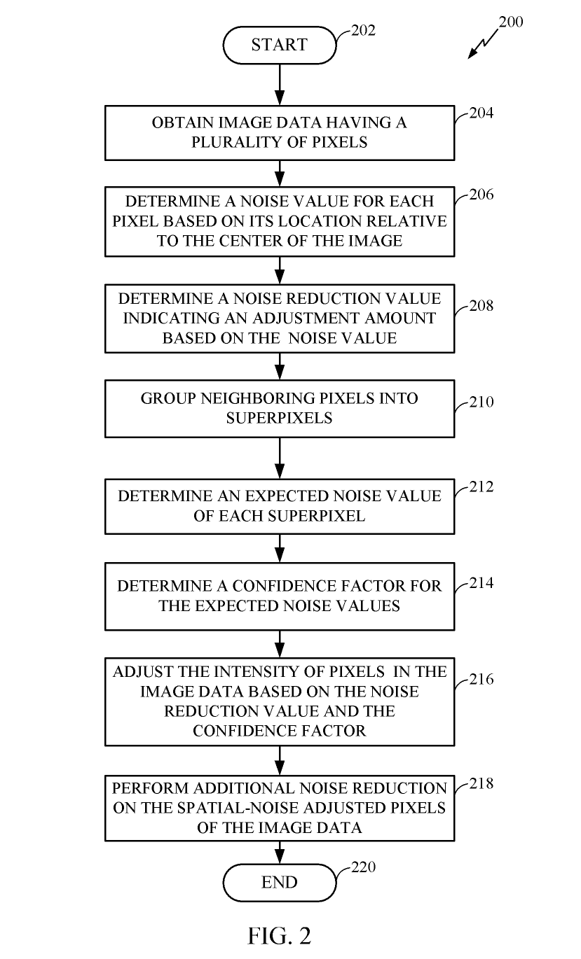

FIG. 2 illustrates one embodiment of a process 200 to reduce image noise implementing a pre-processing algorithm as discussed below to address the spatially-varying noise of an image, resulting in more consistent noise across an image. Process 200 may be used in some embodiments to estimate and correct a spatially-varying noise component and remove the spatially-varying noise from the image data for further noise reduction processing. In some examples, the process 200 may be run on a processor, for example, processor 120 (FIG. 1) and on other components illustrated in FIG. 1 that are stored in memory 140 or that are incorporated in other hardware or software. The process 200 begins at start block 202 and transitions to block 204 wherein image data is obtained from an imaging device. The imaging device may be provided, for example, in a camera, incorporated in a handheld communication device, e.g., a cellular phone or “smartphone,” or a mobile personal data assistant (PDA) including a tablet computer.

To correctly compensate for the varying digital gain of the pixels of the image data, the processor 120 performing CNR needs to know the digital gain applied to different pixels. For local tone mapping processes, in some implementations the digital gain information may be provided to the processor 120 in any structured form, for example, as an array of data, a look-up table (“LUT”) or as a two-dimensional (2D) map corresponding to the image pixels, or corresponding to portions of the image. Process 200 transitions to block 206, wherein, for any pixel (i, j), a noise variance amplification factor (denoted as g(i,j)) is determined relative to the pixels closer to the center of the image that have normal gain applied. For roll-off correction where the digital gain is more circular symmetric, the gain map can be simplified to a radial distance based look up table to calibrate the digital gain change due to the vignette effect. The following equation illustrates the calculation of a noise variance amplification factor shown below in Eqn. 1:

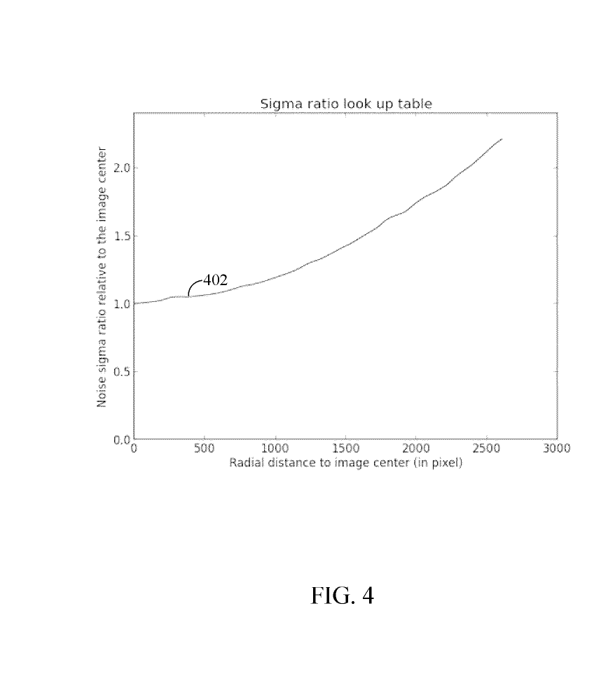

g(i,j)=sigma_ratio_{—}lut(\sqrt{(i−cₓ)²+(j−c_{y})²}) Eqn. 1

Where cₓ and c_{y} are the image center location coordinates and sigma_ratio_lut is a pre-calibrated look-up table which can approximate the roll-off correction digital gain to some extent, the look-up table being stored in memory 135 or 140 and accessible to the processor 120. FIG. 4 shows a plot of an example of noise sigma ratio information that may be in look up table. As shown in FIG. 4, the noise sigma ratio relative to the image center (y-axis) is approximately 1 at the image center. As the radial distance to the image center increases (x-axis), that is, for pixels further from the image center, the noise sigma ratio steadily increases (line 402) from approximately 1 to over 2.

### Spatial Varying Noise Reduction Level

After determining the noise variance amplification factor for each pixel of the image, process 200 transitions from block 206 to block 208, wherein a noise reduction level and an order (or amount of compensation) is determined. To compensate for the spatially varying gain, the noise reduction level can be determined by the processor 120 by how much stronger each pixel's noise sigma is than the pixels near the center of the image having a normal gain. For example, when a pixel's noise is two times stronger than the noise of pixels near the center of the image, a 50% noise reduction level may be applied to compensate for the larger gain. To allow some flexibility when applying CNR, the noise reduction level can be determined using Eqn. 2:

nr(i,j)=f(1/g(i,j)) Eqn. 2

where the nr is the noise reduction level and the function ƒ( ) provides some flexibility to control the noise reduction level (e.g., to control over or under correction). For example, function ƒ( ) can be defined as ƒ(1/g(i,j))=(1/g(i,j))^{order} to control the level of over/under correction based on the parameter “order.”

If order is equal to 1, the algorithm tries to make the noise variance stationary across the whole image. The order is preferably set to one (1) as a default setting to compensate for noise variance across the entire image. However, some images will be blurry if too much noise reduction is applied. Additionally, in some embodiments, some users may prefer to select the amount of noise reduction to be applied to the image. Thus, a user may be able to specify a preference for a sharper image at the cost of higher noise. In this situation, the user may select an order less than one (1) which results in some under-correction of the noise. For other images, a user may want to apply stronger noise reduction, for example, if the image is too noisy. In this situation, the user may select an order greater than one (1) which results in some over-correction of the noise.

In some embodiments, the user may be able to select the order via a user interface, such as that provided by user interface module 170. By allowing the user to control the amount of noise reduction applied to the image, the user can tune the image to individual preferences.

### Super-Pixel Based Noise Reduction

For effective noise reduction, embodiments of the invention include a super-pixel based approach. It is known that the signal to noise ratio improves when each sensor cell receives more light. A similar effect can be achieved by grouping the neighboring pixels (for example, 2×2 or 4×4 pixels) into a representative larger pixel, a “super-pixel.” Process 200 transitions from block 208 to block 210, wherein neighboring pixels are grouped in super-pixels. The grouping factor can be configured differently for different lighting conditions. For a bright light condition, a smaller number of pixels (e.g., 2×2, or 3×3) can be grouped together. For a low-light condition, a bigger number of pixels (e.g., 4×4 or 5×5) may be grouped together to achieve the noise reduction.

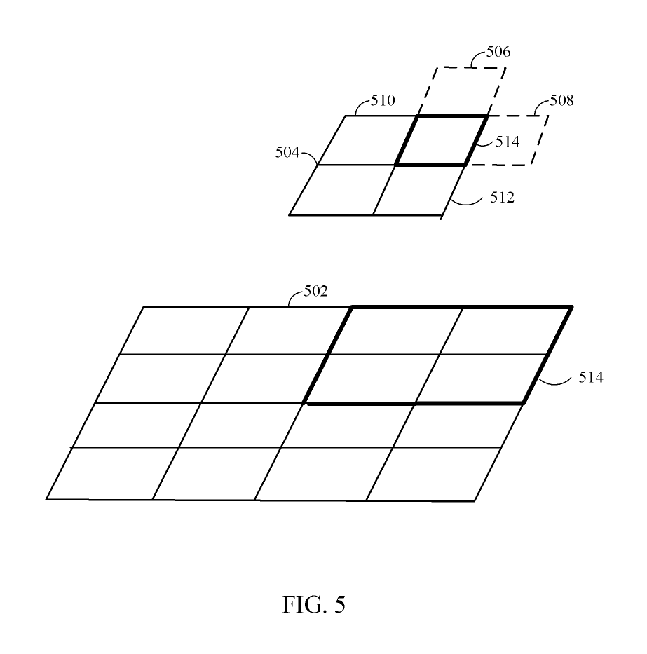

FIG. 5 illustrates one example of how a super pixel may be formed. The lower grid 502 indicates a partial grid of 4×4 pixels of the original image resolution. The upper grid 504 indicates 4 super pixels formed from 2×2 pixels of the original image. Super pixel 514 is identified in both the original image resolution pixel grid 502 and the super pixel grid 504 by the dark line 514. Each pixel in the original image has four neighboring super pixels. For example, super pixel 514, including the four original image pixels of the original image pixel grid 502 and identified by the area enclosed by the dark line, is surrounded by neighboring super-pixels 506, 508, 510, and 512. Each pixel's expected noise free value (Îₚ) can therefore next be calculated in block 212 by averaging the expected noise free value of each pixel within the super-pixel, performing bilinear interpolation between the four neighboring super-pixels, and mapping the expected noise free value back to the pixel of the original image resolution. Once the expected intensity value is determined, the difference between the observed value (Iₚ) and the expected value (Îₚ) is the expected noise (\hat{N}ₚ) shown in Eqn. 3 below:

\hat{N}ₚ=Iₚ−Îₚ Eqn. 3

For the calculated expected noise, we may first estimate the confidence, or probability, that \hat{N}ₚ is indeed the noise component, as is done next in block 214 of process 200. P(\hat{N}ₚ) can be used to represent the confidence. This confidence can be estimated in different ways. Since the noise sigma for each pixel is known, the confidence can be estimated based on noise distribution. In some embodiments, the confidence estimation based on noise distribution (P_{N}) and the non-noise distribution (P_{S}) following the Bayesian estimation is shown in Eqn. 4:

$$P ( {\hat{N}}_{p} ) = \frac{{P}_{N} ( {\hat{N}}_{p} )}{{P}_{S} ( {\hat{N}}_{p} ) + {P}_{N} ( {\hat{N}}_{p} )} \qquad Eqn . 4$$

Once the confidence measure is known from block 214, process 200 transitions to block 216, wherein the noise reduction may be calculated as shown in Eqn. 5:

I′ₚ=Îₚ+nr(i,j)·P(\hat{N}ₚ)·\hat{N}ₚ Eqn. 5

As an alternative to the confidence method discussed above, soft or hard thresholding may also be used to calculate the noise reduction. For example, a traditional soft-thresholding technique is described mathematically as shown in Eqn. 6:

$$\{ \begin{matrix}if ‖ {\hat{N}}_{p} ‖ \leq th , & {I}_{p}^{′} = {\hat{I}}_{p} + nr ( i , j ) \cdot {\hat{N}}_{p} \\ if ‖ {\hat{N}}_{p} ‖ > th , & {I}_{p}^{′} = {\hat{I}}_{p} + {\hat{N}}_{p} - ( 1 - nr ( i , j ) ) \cdot th \cdot sign ( {\hat{N}}_{p} )\end{matrix} \qquad Eqn . 6$$

Soft-thresholding methods can reduce the noise in an image so that pixels with intensity values below the threshold value are reduced or set to lower values, even zero. Contrary to standard or hard-thresholding methods in which values above the threshold are kept and values below the threshold are deleted, the soft-threshold function handles images differently. The soft-threshold allows for smooth transitions between the original and the deleted values. Values slightly below the threshold are not set to zero but are merely attenuated.

With the above procedure applied to the image, the spatially varying (non-stationary) gain can be compensated for and other modules following CNR operations do not need to specially model the spatial varying noise, and hence may have a simpler design. After compensating for the spatially varying gain in block 216 by performing corner noise reduction, process 200 transitions to block 218 wherein additional noise reduction may be performed on the image to compensate for other aberrations, including non-varying noise. Process 200 then transitions to block 220 and ends.

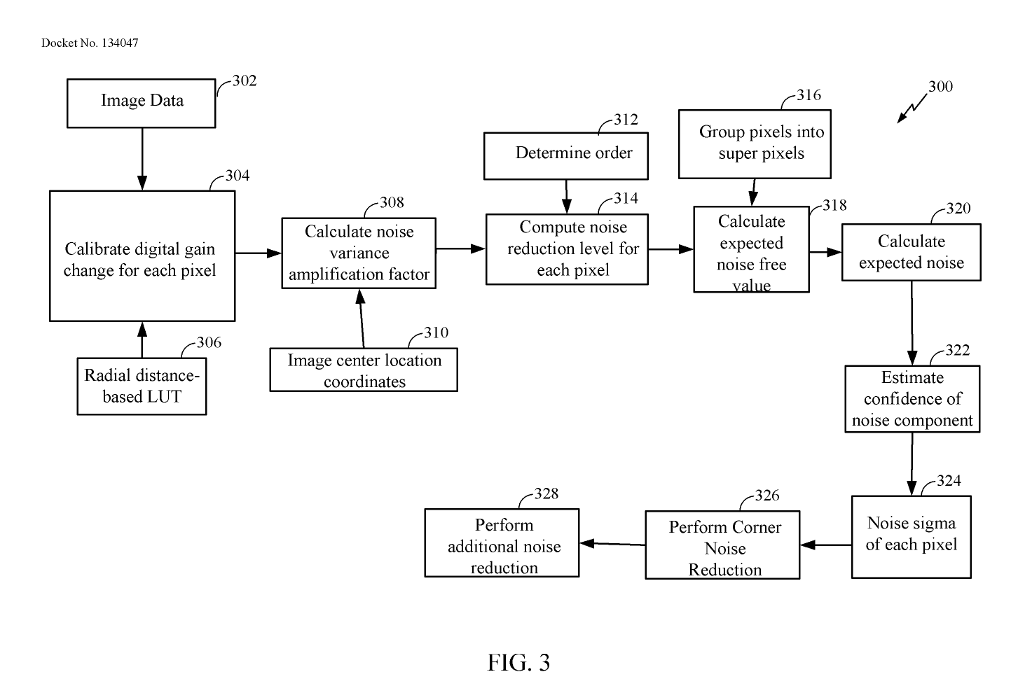

A schematic illustration of process 200 is also illustrated in FIG. 3. Image data 302, such as that obtained from a camera of a mobile device, and a radial distance-based LUT 306 may be used to calibrate the digital gain change for each pixel of the image as shown in block 304.

Once the digital gain change for each pixel is known, this information is then used to calculate the noise variance amplification factor as illustrated in block 308. The noise variance amplification factor is determined using the known image center location coordinates 310. These coordinates can assist in determining the noise variance between the known image center and the edges of the image which may have a noise vignette effect.

After determining the noise variance amplification factor as described above with respect to process 200, the amplification factor for each pixel is used to compute the desired noise reduction level for each pixel as in block 314. As discussed above, the noise reduction level may be modified by the user depending on the user's preference by adjusting the order 312 to over- or under-correct the noise reduction. For most images, a constant or uniform noise level is generally desired, and therefore the order is preferably set to one as a default setting. For some images, the user may desire weaker noise reduction to prevent the image from becoming too blurry. In these situations, the user may select an order less than one. For other images with a high level of noise, the user may desire stronger noise reduction and select an order greater than one.

After calculating the noise reduction level for each pixel in block 314, the noise reduction level is used to calculate the expected noise free value in block 318. To reduce computational complexity, the original pixels may be grouped into super-pixels prior to computing the expected noise free value of each pixel. From the expected noise free value, the expected noise of each pixel may be calculated in block 320. The confidence of the expected noise component may be estimated in block 322. Alternatively, soft-thresholding functions may be used as discussed above instead of estimating the confidence of the noise component. The noise sigma of each pixel is next calculated as shown in block 324 and finally, corner noise reduction may be performed on the image as shown in block 326. The image data with corner noise reduction performed may then be passed to additional processing modules wherein additional noise reduction may be performed, as shown in block 328.

It should be realized that embodiments of the invention may be utilized in a wireless communication device. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, a memory including instructions or modules for carrying out the CNR process discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

### Clarifications Regarding Terminology

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A system for digital image noise reduction, comprising:
a memory for storing image data, the image data comprising a plurality of pixels; and
a processor configured to perform a method comprising
determining a noise variance amplification factor for each pixel;
determining a noise reduction level and an order to apply to each pixel;
calculating the expected noise of each pixel;
estimating a confidence factor of the expected noise based on a noise distribution of the image;
performing noise reduction for each pixel of the image based on the expected noise, the confidence factor, the noise reduction level and the order to obtain noise reduced image data; and
storing the noise reduced image data in the memory.

2. The system of claim 1 further comprising an imaging device configured to capture image data.

3. The system of claim 1, wherein determining the noise reduction level and order to apply to each pixel is based on a noise level of each pixel of the image as compared to a pixel having normal digital gain applied.

4. The system of claim 1 further comprising using a radial distance based look up table to calibrate a noise property distortion of each pixel due to image vignetting.

5. The system of claim 1, wherein the processor is further configured to group the plurality of pixels into a plurality of super pixels containing one or more pixels of the image data.

6. The system of claim 1, wherein the order may be input by a user.

7. A processor for reducing noise artifacts in a digital image, the processor configured with a plurality of modules, comprising:
a first module configured to determine noise artifacts in a digital image having a plurality of pixels; and
a second module configured to determine an amplification factor for each pixel to compensate for image vignetting by reducing the determined noise artifacts by applying a noise filter having a spatially varying digital gain, such that noise artifacts near the center of the image are processed differently than the noise artifacts near the corners of the captured digital image.

8. The processor of claim 7, wherein the second module is further configured to determine a noise reduction level and order based on a noise level of each pixel of the image as compared to a pixel having normal digital gain applied.

9. The processor of claim 7, wherein the second module is further configured to use a radial distance based look up table to calibrate the noise property distortion due to image vignetting.

10. The processor of claim 7, wherein pixels of the captured digital image are grouped into super pixels containing two or more of the pixels of the captured digital image.

11. The processor of claim 7, wherein the pixels are grouped into super pixels depending on a lighting condition of the capture digital image.

12. The processor of claim 7, wherein a roll-off correction is performed on the digital image prior to applying a noise filter having a spatially varying digital gain.

13. A method of reducing noise artifacts in a captured digital image, comprising:
determining noise artifacts in a digital image having a plurality of pixels; and
applying a noise filter having a spatially varying digital gain to determine an amplification factor for each pixel to compensate for image vignetting in the digital image so that noise artifacts near the center of the image are processed differently than the noise artifacts near the corners of the captured digital image.

14. The method of claim 13 further comprising calibrating a digital gain change for each pixel.

15. The method of claim 13 further comprising determining an order level that controls the level of compensation globally and computing a noise reduction level for each pixel based on the determined order level.

16. The method of claim 13 further comprising grouping the plurality of pixels into a plurality of super pixels containing one or more pixels of the image data.

17. The method of claim 13 further comprising calculating an expected noise value of each of the plurality of pixels.

18. The method of claim 13 further comprising estimating a confidence factor of the expected noise value based on a noise distribution of the image.

19. The method of claim 13 further comprising performing noise reduction for each of the plurality of pixels of the image based on the expected noise, the confidence factor, the noise reduction level and the order to obtain noise reduced image data.

20. The method of claim 13 further comprising storing the noise reduced image data in a memory for further processing.
